(19) United States
(12) Patent Application Publication
(10) Pub. No.: US 2003/0130426 A1
(43) Pub. Date: Jul. 10, 2003

(54) Method of grafting polymaleimides to alkenyl butyl rubbers

(75) Inventors: Xiaorong Wang, Hudson, OH (US); James E. Hall, Mogadore, OH (US)

Correspondence Address: Chief Intellectual Property Counsel, Bridgestone/Firestone, Inc., 1200 Firestone Parkway, Akron, OH, 44317-0001, US

(73) Assignee: Bridgestone Corp.

(21) Appl. No.: 10/036,655

(22) Filed: Dec. 31, 2001

(51) Int. Cl. C08F 8/30

(52) U.S. Cl. 525/178

(57) ABSTRACT

A reacted polymer composition including a poly(alkenyl-co-maleimide), a copolymer, and a compatibilizer residue. The copolymer includes at least one alkenyl contributed unit and at least one additional alkenyl contributed unit including a halogen substituent.

### BACKGROUND OF THE INVENTION

The present invention is directed to the formation of thermoplastic elastomers (TPEs), specifically those having low creep.

Two or more polymers may be blended together to form a wide variety of random or structured morphologies to obtain products that potentially offer desirable combinations of characteristics. However, it may be difficult or even impossible in practice to achieve many potential combinations through simple blending. Frequently, the two polymers are thermodynamically immiscible, which precludes generating a truly homogeneous product. While a two-phase structure may be desirable for certain applications, the situation at the interface between these two phases very often leads to problems. The typical case is one of high interfacial tension and poor adhesion between the two phases. Interfacial tension contributes, along with high viscosities, to the inherent difficulty in imparting the desired degree of dispersion to random mixtures and to their subsequent lack of stability, giving rise to gross separation or stratification during later processing or use. Poor adhesion can lead, in part, to the weak and brittle mechanical behavior often observed in dispersed blends and may render some highly structured morphologies impossible.

One method for overcoming the problems associated with blending polymers is direct reaction of the polymers. In this method, two or more polymers are directly linked to one another resulting in many of the same qualities sought from polymer blending. This process can be complicated where the polymers being reacted have different solubilities because this can result in difficulty bringing together the reactive constituents.

Polyimides and polyalkenyl rubbers are two groups of polymers used to produce tire rubbers because desirable results can be achieved through a combination of certain characteristics of these polymers. However, these two classes of polymers are generally immiscible, leading to difficulties in blending. In addition, polyimides are typically insoluble in organic solvents and polyalkenyl rubbers are typically insoluble in aqueous solvents, rendering direct reaction of the two polymers difficult. Accordingly, the above-discussed methods of direct reaction are not readily adaptable to polyimides and polyalkenyl rubbers.

Development of an effective method for forming polyimides and polyalkenyl rubbers would be of great utility.

### SUMMARY OF THE INVENTION

According to one embodiment of the invention, a polymer composition including a poly(alkenyl-co-maleimide), a copolymer, and a compatibilizer residue is provided. The copolymer includes at least one alkenyl contributed unit and at least one alkenyl contributed unit including a halogen substituent.

According to another embodiment of the invention, a method for forming a polymer composition by reacting a poly(alkenyl-co-maleimide) and a copolymer in the presence of a compatibilizer is also provided. The copolymer includes at least one alkenyl contributed unit and at least one alkenyl contributed unit including a halogen substituent.

The following definitions apply herein throughout unless a contrary intention is expressly indicated:

“vinyl aromatic hydrocarbon” and “alkenyl benzene” are used interchangeably;

“maleic anhydride” encompasses dicarboxylic acids, including maleic anhydride, which can form a copolymer with alkenyl benzene, R¹R²ethylene, or alkyl vinyl ether, the copolymer having dicarboxylic acid units that are capable of reaction with an amine functional group;

“maleimide” encompasses the reaction product of ammonia and the dicarboxylic acids described above;

“R¹R²ethylene” as used herein encompasses compounds of the general formula:

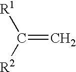

where R¹ and R² are independently H or substituted C₁-C₂₀ alkyl groups;

“poly(alkenyl-co-maleimide)” includes at least poly(alkenylbenzene-co-maleimide), poly(R¹R²ethylene-co-maleimide), and poly(alkyl vinyl ether-co-maleimide).

### DETAILED DESCRIPTION OF ILLUSTRATIVE EMBODIMENTS

The present invention is directed to a low creep thermoplastic elastomer (TPE) composition. The composition includes imide polymer domains and polyalkenyl domains. A preferred imide polymer is poly(alkenyl-co-maleimide). Without being bound by theory, it is believed that the compatibilizer aids a reaction between the imide polymer domains and the polyaklenyl polymer domains by improving solubility of the reactant polymers.

The imide polymer can be formed by imidizing a poly(alkenyl-co-maleic anhydride) with ammonia. For purposes of this invention, poly(alkenyl-co-maleimide) and poly(alkenyl-co-maleic anhydride) encompass random and stereospecific copolymers, including copolymers having alternating alkenyl-contributed units (i.e., units derived from an alkenyl benzene, alkyl or alkyl vinyl ether) and maleimide- or maleic anhydride-contributed units (e.g., units derived from a maleimide or a maleic anhydride) along the polymer backbone. Exemplary copolymers include alternating copolymers with a ratio of about 50% alkenyl contributed units and about 50% maleimide contributed units. However, copolymers with a ratio of at least about 20% alkenyl contributed units are contemplated for use. The poly(alkenyl-co-maleimide) domains preferably have a Mw between about 10,000 and 500,000, more typically between about 5,000 and 450,000.

Specific examples of poly(alkenyl-co-maleimide) polymers representative of the imide polymer domain include poly(alkenyl benzene-co-maleimide), poly(R¹R²ethylene-co-maleimide), and poly(alkyl vinyl ether-co-maleimide).

Exemplary alkenyl benzene contributed monomer units of the poly(alkenyl benzene-co-maleimide) domain include one or more of styrene, methyl styrene, 1-vinyl-naphthalene, 2-vinyl-naphthalene, 1-oc-methyl vinyl naphthalene, 2-α-methyl naphthalene, as well as alkyl, cycloalkyl, aryl, alkaryl, and aralkyl derivatives thereof, in which the total number of carbon atoms in the combined hydrocarbon is generally not greater than 18, as well as any di-or tri-vinyl aromatic hydrocarbons. Preferred vinyl aromatic hydrocarbons are styrene and methyl styrene.

Exemplary R¹ and R² groups of R¹R²ethylenes contributed monomer units of the poly(R¹R²ethylene-co-maleimide) domain and alkyl groups of the alkyl vinyl ethers contributed monomer units of the poly(alkyl vinyl ether-co-maleimide) domain independently include methyl, ethyl, propyl, isopropyl, butyl, isobutyl, pentyl, isopentyl, hexyl, heptyl, octyl, nonyl, decyl, undecyl, dodecyl, tredecyl, tetradecyl, pentadecyl, hexadecyl, heptadecyl, octadecyl, nonadecyl, eicosyl, cyclopropyl, 2,2demethylcyclopropyl, cyclopentyl, cyclohexyl, methoxymethyl, methoxyethyl, methoxypropyl, methoxybutyl, methoxypentyl, methoxyhexyl, methoxyoctyl, methoxynonyl, ethoxydecyl, ethoxymethyl, ethosyethyl, ethoxypropyl, ethoxybytyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyheptyl, propoxyoctyl, propoxynonyl, propoxydecyl, butoxymethyl, butoxyethyl, butoxypropoyl, butoxybutyl, butoxypentyl, butoxyhexyl, butoxyheptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxyoctyl, octyloxynonyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-bethylpentyl, 2-methylhexyl, 2-methylheptyl, 2-methyloctyl, 2,3,3-trimethylbutyl, 3-methylpentyl, 2,3-dimethylpentyl, 2,4-dimethylpentyl, 2,3,3,4-tetramethylpentyl, 3-methylhexyl, or 2,5-dimethylhexyl. R¹ and R² may also be hydrogen.

Preferred RlR²ethylene contributed units of the poly(R¹R²ethylene-co-maleimide) domains include ethylene, propylene, butylene, isobutylene, pentene, hexene, heptene, etc., as well as any di- or tri- alkene, or mixtures thereof, with preference given to isobutylene.

Preferred alkyl vinyl ether contributed monomer units of the poly(alkylvinyl ether-co-maleimide) domains include methylvinyl ether, ethylvinyl ether, propylvinyl ether, butylvinyl ether, and any other alkyl vinyl ether wherein the number of carbons in the alkyl substituent is not greater than about 12, and mixtures thereof. A preferred alkylvinyl ether is methylvinyl ether.

The polyalkenyl domain includes copolymers of alkenyl groups, with at least one monomer contributed unit containing a halogen substituent. Preferably, between about 0.1 and 5% by weight, most preferably between about 0.5 and 2.5% by weight of the units in the polyalkenyl domain contain a halide group. Suitable halogens are one or more of F, Cl, Br, and I. Exemplary halogen substituent alkenyl groups in the polyalkenyl domain are one or more of halogen substituent alkenyl benzene, halogen substituent R¹R²ethylene, and halogen substituent alkyl vinyl ether. The alkenyl group copolymers forming the polyalkenyl domain will preferably have a Mw from about 5000 to 450,000.

Exemplary alkenyl benzene contributed units of the polyalkenyl domain can be derived from one or more of styrene, methyl styrene, 1-vinyl-naphthalene, 2-vinyl-naphthalene, 1-α-methyl vinyl naphthalene, 2-α-methyl naphthalene, as well as alkyl, cycloalkyl, aryl, alkaryl, and aralkyl derivatives thereof, in which the total number of carbon atoms in the combined hydrocarbon is generally not greater than 18, as well as any di-or tri-vinyl aromatic hydrocarbons. A preferred alkenyl benzene isp-alkyl styrene.

Exemplary R¹ and R² groups of R¹R²ethylene contributed units and alkyl groups of alkyl vinyl ether contributed units of the polyalkenyl domain idependently include from methyl, ethyl, propyl, isopropyl, butyl, isobutyl, pentyl, isopentyl, hexyl, heptyl, octyl, nonyl, decyl, undecyl, dodecyl, tredecyl, tetradecyl, pentadecyl, hexadecyl, heptadecyl, octadecyl, nonadecyl, eicosyl, cyclopropyl, 2,2-demethylcyclopropyl, cyclopentyl, cyclohexyl, methoxymethyl, methoxyethyl, methoxypropyl, methoxybutyl, methoxypentyl, methoxyhexyl, methoxyoctyl, methoxynonyl, ethoxydecyl, ethoxymethyl, ethoxyethyl, ethoxypropyl, ethoxybutyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyheptyl, propoxyoctyl, propoxynonyl, propoxydecyl, butoxymethyl, butoxyethyl, butoxypropoyl, butoxybutyl, butoxypentyl, butoxyhexyl, butoxygeptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxyoctyl, octyloxynonyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-bethylpentyl, 2-methylhexyl, 2-methylheptyl, 2-methyloctyl, 2,3,3-trimethylbutyl, 3-methylpentyl, 2,3-dimethylpentyl, 2,4-dimethylpentyl, 2,3,3,4-tetramethylpentyl, 3-methylhexyl, or 2,5-dimethylhexyl. R¹ and R² may also be hydrogen.

Preferred R¹R²ethylene contributed units of the polyalkenyl domain include alkenes such as ethylene, propylene, butylene, isobutylene, pentene, hexene, heptene, etc., as well as any di- or tri-alkene, or mixtures thereof, with preference given to isobutylene.

Preferred alkyl vinyl ether contributed units of the polyalkenyl domain include alkylvinyl ethers such as methylvinyl ether, ethylvinyl ether, propylvinyl ether, butylvinyl ether, and any other alkyl vinyl ether wherein the number of carbons in the alkyl substituent is not greater than about 12, and mixtures thereof. A preferred alkylvinyl ether is methylvinyl ether.

Preferably, the polyalkenyl domain polymer includes units contributed by more than one type of monomer identified as suitable for the polyalkenyl domain. For example, a preferred polyalkenyl domain includes poly(ethylene-co-propylene-co-bromo-p-methylstyrene). Another preferred polyalkene domain includes poly(isobutylene-co-methyl styrene-co-bromo-p-methylstyrene).

The imide domain polymer can be manufactured by a variety of known methods. For example, the poly(alkenyl-co-maleimide) domain can be formed by reacting a poly(alkenyl-co-maleic anhydride) in the presence of ammonia at temperatures from about 100° to about 300° C. and at a pressure from about slightly above vacuum to about 2100 kPa, under substantially dry conditions. The reactants are preferably dry mixed in the absence of solvents in a suitable mixing apparatus such as a Brabender mixer. Purging the mixer with an inert gas such as N₂ prior to charging of the reactants is also preferred. The ammonia may be added in a single charge, or in sequential partial charges into the reactor containing a charge of poly(alkenyl-co-maleic anhydride). Preferably, the ammonia is charged in ratio between 0.8 to 1.0 moles of ammonia per monomer contributed units of maleic anhydride in the poly(alkenyl-co-maleic anhydride).

After the imide domain polymer is formed, it is reacted with the polyalkenyl domain polymer in the presence of a compatibilizer. Typically, the imide domain polymer and polyalkenyl domain polymers will be combined at a ratio of about between 4:1 and 0.5:1, preferably about 2:1. Preferred compatibilizers are at least partially soluble in water and organic solvents to increase mutual solubility of the different polymers, resulting in improved reactivity. Exemplary compatibilizers include alkylene carbonates such as propylene carbonate and ethylene carbonate, 2-keto-4-(2,5,8,11-tetra oxadodecyl) 1,3-dioxalane, bis(2-ethyl hexyl sebacate), diethyl phthalate, polyethylene glycol, tetra ethylene glycol, tetra ethylene glycol dimethyl ether, 12-crown-4-ether, and liquid polyethylene oxide. A preferred compatibilizer is propylene carbonate.

Formation of the final polymer composition is carried out by reacting the imide polymers with the alkenyl copolymers in the presence of a compatibilizer at a temperature between about 100 and 250° C., under substantially dry conditions. The reactants are preferably dry mixed in the absence of solvents in a suitable mixing apparatus, such as an open-type mixing roll, closed-type Banbury mixer, closed-type Brabender mixer, extruding machine, kneader, continuous mixer, etc., a Brabender mixer. Purging the mixer with an inert gas such as N₂ before addition of the reactants may be preferred. The reactants may be charged into the mixer simultaneously or sequentially. The mixing speed is preferably between about 45 and 95 rpm, more preferably between about 50 and 90 rpm.

The final composition has little or no remaining compatibilizer because many of the aforementioned compatibilizers boil off during reaction, resulting in substantially pure copolymers having imide and alkenyl domains.

The maleimide units within the backbone of the imide polymer are believed to react with the halide groups within the alkenyl copolymers. The resulting product is a TPE with distinct imide and alkenyl domains. Preferably, the imide domains will comprise about 5 to 95% by weight of the overall polymer while the polyalkenyl domains will comprise between about 95 and 5 wt. % of the overall polymer. However, each individual alkenyl domain is preferably less than about 200 nm, more preferably less than about 100 nm. Advantageously, the small size of the alkenyl domain provides a substantially transparent polymer composition. The resulting polymer composition demonstrates low creep and high service temperatures. The polymer composition may be used in the manufacture of tires, preferably in the manufacture of side wall components of tires. Additionally, the polymer composition may be generally employed in applications in which TPEs are favorably used.

The subject invention is described in more detail with reference to the following non-limiting examples, which are presented for the purposes of illustration only and should not be construed in a limiting sense.

### EXAMPLES

### Example 1

To a Brabender mixer (˜55 g capacity) equipped with a roller blade and N₂ purging, 15 g Isoban™ 306, poly(isobutylene-co-maleimide) (Kuraray, Tokyo, Japan) and 5 g propylene carbonate (Aldrich Chem. Co., Milwaukee, Wis.) were added. The mixer was initially set to 140° C. and 60 rpm and run at these conditions for 2 minutes prior to a charge of 2 g propylene carbonate being added. 3 minutes later, a charge of 30 g Exxpro™ 96-4, partially brominated isobutylene-methylstyrene rubber (Exxon Chemical, Houston, Tex.) was added to the mixer. After an additional 2 minutes of mixing, another charge of 3 g propylene carbonate was added to the mixer. Mixing continued for 20 more minutes. During this period the mixing torque built from ˜100 mg to ˜3,000 mg. Agitation was stopped and the product was removed from the mixer.

### Examples 2-4

To the Brabender mixer (˜55 g capacity) that was initially set to 140° C. and 60 rpm, a charge of Isoban™ 306 and propylene carbonate was added. After 2 minutes, a charge of Exxpro 96-4 and a second charge of propylene carbonate was added into the mixer. The material was mixed at those conditions, the agitation was turned off, and the product removed from the mixer.

Specific reaction conditions for each example are shown in Table 1.

TABLE 1
Reaction conditions of Examples 2-4

| | | 1st charge | | 2nd charge | mixing |
|---|---|---|---|---|---|
| Exam- | Isoban ™ | propylene | Exxpro ™ | propylene | time |
| ple | 306 | carbonate (g) | 96-4 | carbonate (g) | (m) |
| 2 | 9 | 4.5 | 36 | 4.5 | 22 |
| 3 com- | 0 | 0 | 36 | 9 | 18 |
| parative | | | | | |
| 4 | 9 | 4.5 | 36 | 4.5 | 14 |

### Example 5

9 g Isoban™ 306 and 4 g propylene carbonate were premixed at 24° C. for about 5 hours. The mixture was charged to a Brabender mixer that was initially set to 140 ° C. and 60 rpm. After 4 minutes, a charge of 36 g Exxpro™ 96-4 and was added to the mixer. The product was removed from the mixer after an additional 10 minutes of mixing.

### Example 6 (Comparative)

A charge of 36 g Exxpro™ 96-4 and 9 g Isoban™ 306 was added to a Brabender mixer. The mixture was stirred at 60 rpm and 140° C. for 20 minutes. The product was then removed from the mixer.

The products of Examples 1-6 were molded into sheets and cylinder buttons at ˜160° C. Ring samples were cut from these sheets for tensile measurements. The detail of the physical properties of the final products are shown in Table 2.

TABLE 2

| | | Shore | | /Eb (kPa) | Compression |
|---|---|---|---|---|---|
| | Appearance | A | Tb | (/%) | Set @ 100 C. |
| 1 | Transparent | 97 | 5206 | 172 | 73.1% |
| 2 | Transparent | 65 | 3431 | 257 | 48.5% |
| 3 comparative | Opaque | 16 | 420 | 422 | Flow |
| 4 | Transparent | 37 | 4334 | 425 | 72.5% |
| 5 | Transparent | 33 | 3266 | 742 | 77.7% |
| 6 comparative | Opaque | 27 | 620 | 270 | Flow |

As evidenced by the compression set measurements in Table 2, the products of examples 1, 2, 4, and 5 were TPEs with low creep. Furthermore, the TPEs were transparent. Examples 3 and 6, both comparative, without propylene carbonate and Isoban™ 306 resulted in opaque polymers with high flow rates.

The invention has been described with reference to certain preferred embodiments. Obviously, modifications and alterations will occur to others upon reading and understanding the preceding description. The invention is to be construed as including all such modifications and alterations insofar as they come within the scope of the appended claims or the equivalents thereof.

We claim:

1. A polymer composition comprising:
a. poly(alkenyl-co-maleimide);
b. a copolymer including at least one alkenyl contributed unit, and at least one additional alkenyl contributed unit including a halogen substituent; and
c. a compatiblilizer residue.

2. The composition of claim 1 wherein the alkenyl contributed units of said poly(alkenyl-co-maleimide) and the alkenyl contributed units of said copolymer are selected from one or more of R¹R²ethylene, alkyl vinyl ether, and vinyl-substituted aromatic hydrocarbon.

3. The composition of claim 2 wherein the R¹ and R² groups of said R¹R²ethylene contributed monomer units and the alkyl groups of said alkyl vinyl ether contributed monomer units are independently selected from methyl, ethyl, propyl, isopropyl, butyl, isobutyl, pentyl, isopentyl, hexyl, heptyl, octyl, nonyl, decyl, undecyl, dodecyl, tredecyl, tetradecyl, pentadecyl, hexadecyl, heptadecyl, octadecyl, nonadecyl, eicosyl, cyclopropyl, 2,2-demethylcyclopropyl, cyclopentyl, cyclohexyl, methoxymethyl, methoxyethyl, methoxypropyl, methoxybutyl, methoxypentyl, methoxyhexyl, methoxyoctyl, methoxynonyl, ethoxydecyl, ethoxymethyl, ethoxyethyl, ethoxypropyl, ethoxybytyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyheptyl, propoxyoctyl, propoxynonyl, propoxydecyl, butoxymethyl, butoxyethyl, butoxypropoyl, butoxybutyl, butoxypentyl, butoxyhexyl, butoxygeptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxyoctyl, octyloxynonyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-bethylpentyl, 2-methylhexyl, 2-methylheptyl, 2-methyloctyl, 2,3,3-trimethylbutyl, 3-methylpentyl, 2,3-dimethylpentyl, 2,4-dimethylpentyl, 2,3,3,4-tetramethylpentyl, 3-methylhexyl, or 2,5-dimethylhexyl.

4. The composition of claim 2 wherein one or both of R¹ and R² of said R¹R²ethylene are hydrogen.

5. The composition of claim 2 wherein said vinyl-substituted aromatic hydrocarbon is chosen from any one or combination of styrene, methylstyrene, 1-vinylnaphthalene, 2-vinylnaphthalene, 1-α-methylvinylnaphthalene, 2-α-methylvinylnaphthalene, as well as alkyl, cycloalkyl, aryl, alkaryl, and aralkyl derivatives thereof, in which the total number of carbon atoms in the combined hydrocarbon is generally not greater than 18, as well as any di- or tri-vinyl-substituted aromatic hydrocarbons.

6. The composition of claim 2 wherein said vinyl-substituted aromatic hydrocarbon monomer units are methyl-styrene.

7. The composition of claim 1 wherein said maleimide is the reaction product of maleic anhydride and ammonia.

8. The composition of claim 1 wherein said halogen substituent is one or more of F, Cl, Br, and I.

9. The composition of claim 1 wherein said compatibilizer residue is derived from one or more of propylene carbonate, ethylene carbonate, 2-keto-4-(2,5,8, 1-tetra oxadodecyl) 1 ,3-dioxalane), bis(2-ethyl hexyl sebacate), diethyl phthalate, polyethylene glycol, tetra ethylene glycol, tetra ethylene glycol dimethyl ether, 12-crown-4-ether, and liquid polyethylene oxide.

10. The composition of claim 1 wherein said compatibilizer residue is derived from propylene carbonate.

11. The composition of claim 1 wherein said composition is substantially transparent.

12. A method for forming a polymer composition comprising reacting a poly(alkenyl-co-maleimide) and a copolymer including at least one alkenyl contributed unit and at least one additional alkenyl contributed unit further including a halogen substituent, in the presence of a compatibilizer.

13. The method of claim 12 wherein the alkenyl contributed units of said poly(alkenyl-co-maleimide) and the alkenyl contributed units of said copolymer are selected from one or more of R¹R²ethylene, alkyl vinyl ether, and vinyl-substituted aromatic hydrocarbon.

14. The method of claim 13 wherein the R¹ and R² of said R¹R²ethylene contributed units and the alkyl of said alkyl vinyl ether contributed units are independently selected from methyl, ethyl, propyl, isopropyl, butyl, isobutyl, pentyl, isopentyl, hexyl, heptyl, octyl, nonyl, decyl, undecyl, dodecyl, tredecyl, tetradecyl, pentadecyl, hexadecyl, heptadecyl, octadecyl, nonadecyl, eicosyl, cyclopropyl, 2,2-demethylcyclopropyl, cyclopentyl, cyclohexyl, methoxymethyl, methoxyethyl, methoxypropyl, methoxybutyl, methoxypentyl, methoxyhexyl, methoxyoctyl, methoxynonyl, ethoxydecyl, ethoxymethyl, ethoxyethyl, ethoxypropyl, ethoxybytyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyheptyl, propoxyoctyl, propoxynonyl, propoxydecyl, butoxymethyl, butoxyethyl, butoxypropoyl, butoxybutyl, butoxypentyl, butoxyhexyl, butoxygeptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxyoctyl, octyloxynonyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-bethylpentyl, 2-methylhexyl, 2-methylheptyl, 2-methyloctyl, 2,3,3-trimethylbutyl, 3-methylpentyl, 2,3-dimethylpentyl, 2,4-dimethylpentyl, 2,3,3,4-tetramethylpentyl, 3-methylhexyl, or 2,5-dimethylhexyl.

15. The method of claim 13 wherein one or both of R¹ and R² of said R¹R²ethylene are hydrogen.

16. The method of claim 13 wherein said vinyl-substituted aromatic hydrocarbon is chosen from any one or combination of styrene, methylstyrene, 1-vinylnaphthalene, 2-vinylnaphthalene, 1-cc-methylvinylnaphthalene, 2-α-methylvinylnaphthalene, as well as alkyl, cycloalkyl, aryl, alkaryl, and aralkyl derivatives thereof, in which the total number of carbon atoms in the combined hydrocarbon is generally not greater than 18, as well as any di- or tri-vinyl-substituted aromatic hydrocarbons.

17. The method of claim 12 wherein said maleimide is the reaction product of maleic anhydride and ammonia.

18. The method of claim 12 wherein said halogen substituent is one or more of F, Cl, Br, and I.

19. The method of claim 12 wherein said compatibilizer is one or more of propylene carbonate, ethylene carbonate, 2-keto-4-(2,5,8,11-tetra oxadodecyl) 1,3-dioxalane), bis(2-ethyl hexyl sebacate), diethyl phthalate, polyethylene glycol, tetra ethylene glycol, tetra ethylene glycol dimethyl ether, 12-crown-4-ether, and liquid polyethylene oxide.

20. The method of claim 11 wherein the reaction is carried out at a temperature between about 100° and 250° C.
